(19) United States
(12) Patent Application Publication
(10) Pub. No.: US 2007/0152593 A1
(43) Pub. Date: Jul. 5, 2007

(54) PLASMA DISPLAY PANEL AND METHOD FOR PRODUCING THE SAME

(75) Inventors: Bo Hyun Kim, Suwon-si (KR); Min Soo Park, Seoul (KR); Deok Hai Park, Daegu (KR); Byung Gil Ryu, Seoul (KR); Young Sung Kim, Yongin-si (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 11/619,308

(22) Filed: Jan. 3, 2007

(30) Foreign Application Priority Data
Jan. 4, 2006 (KR) 10-2006-0000849
Jan. 6, 2006 (KR) 10-2006-0001884

(51) Int. Cl. H01J 17/49

(52) U.S. Cl. 313/587; 313/582

(57) ABSTRACT

A plasma display panel with low firing voltage is disclosed. The plasma display panel includes an upper panel and a lower panel facing each other through barrier ribs wherein the upper panel includes a first protective film composed of magnesium oxide and a second protective film formed on the first protective film and composed of a secondary electron-emitting material.

This application claims the benefit of Korean Patent Application No. 10-2006-0000849, filed on Jan. 4, 2006 and Korean Patent Application No. 10-2006-0001884, filed on Jan. 6, 2006, which are hereby incorporated by reference in their entirety.

### BACKGROUND

1. Technical Field

This document relates to a plasma display panel, and more particularly, to protective films of a plasma display panel.

2. Discussion of the Related Art

Plasma display panels include an upper panel, a lower panel, and barrier ribs formed between the upper and lower panels to define respective discharge cells. A major discharge gas, such as neon, helium or a mixed gas thereof, and an inert gas containing a small amount of xenon (Xe) are filled within the discharge cells. When a high-frequency voltage is applied to produce discharge in the discharge cells, vacuum ultraviolet rays are generated from the inert gas to cause phosphors present between the barrier ribs to emit light, and, as a result, images are created. Such plasma display panels have attracted more and more attention as next-generation display devices due to their small thickness and light weight.

FIG. 1 is a perspective view showing the structure of a plasma display panel. As shown in FIG. 1, the plasma display panel includes an upper panel 100 and a lower panel 110 integrally joined in parallel to and at a certain distance apart from the upper panel. The upper panel 100 includes an upper glass plate 101 as a display plane on which images are displayed and a plurality of sustain electrode pairs, each of which consists of a scan electrode 102 and a sustain electrode 103, arranged on the upper glass plate 101. The lower panel 110 includes a lower glass plate 111 and a plurality of address electrodes 113 arranged on the lower glass plate 111 so as to cross the plurality of sustain electrode pairs.

Barrier ribs 112, which may be, for example, stripe type or well type, for forming a plurality of discharge spaces or discharge cells are arranged parallel to each other on the lower panel 110. A plurality of address electrodes 113, which act to perform address discharge, are arranged in parallel with respect to the barrier ribs to generate vacuum ultraviolet rays. Red (R), green (G) and blue (B) phosphors 114 are applied to upper sides of the lower panel 110 to emit visible rays upon address discharge, and, as a result, images are displayed. A lower dielectric layer 115 is formed between the address electrodes 113 and the phosphors 114 to protect the address electrodes 113.

An upper dielectric layer 104 is formed on the sustain electrode pairs 103, and a protective layer 105 is formed on the upper dielectric layer 104. The upper dielectric layer 104, which is included in the upper panel 100, is worn out due to the bombardment of positive (+) ions upon discharge of the plasma display panel. Thus, short circuiting of the electrodes may be caused by metal elements, such as sodium (Na). To address this problem, a magnesium oxide (MgO) thin film as the protective layer 105 is formed on the upper dielectric layer 104 by coating to protect the upper dielectric layer 104. Magnesium oxide sufficiently withstands the bombardment of positive (+) ions and has a high secondary electron emission coefficient, thus achieving a low firing voltage. Accordingly, the protective layer is formed to operate the plasma display panel at a low voltage. This low-voltage operation leads to a reduction in the power consumption of the panel, thus contributing to a reduction in the production costs of the panel as well as an improvement in the discharge efficiency and brightness of the panel.

However, such a conventional protective layer of magnesium oxide may fail to sufficiently lower the discharge voltage of plasma display panels, on account of its material characteristics. Specifically, magnesium oxide has a low secondary electron emission coefficient with respect to ions escaping from plasma.

### SUMMARY OF THE INVENTION

In one general aspect, a plasma display panel that has improved secondary electron emission characteristics and a method for producing such a plasma display panel are provided.

Implementations of the plasma display panel may have low firing voltage, high brightness, improved discharge efficiency and reduced power consumption, which result from improved secondary electron emission characteristics.

Implementations of the plasma display panel may emit an increased number of secondary electrons due to the bombardment of electrons.

Additional features will be apparent from the description which follows, including the drawings, and the claims.

In another general aspect, a plasma display panel includes an upper panel and a lower panel facing each other through barrier ribs, wherein the upper panel includes a first protective film composed of magnesium oxide and a second protective film formed on the first protective film and composed of a secondary electron-emitting material.

In another general aspect, a method for producing a plasma display panel includes forming a first protective film composed of magnesium oxide on a dielectric layer of an upper panel and forming a second protective film composed of a secondary electron-emitting material on the first protective film.

It is to be understood that both the foregoing general description and the following detailed description are exemplary and explanatory and are intended to provide further explanation of the subject matter claimed.

### BRIEF DESCRIPTION OF THE DRAWINGS

FIG. 1 is a perspective view of a plasma display panel;

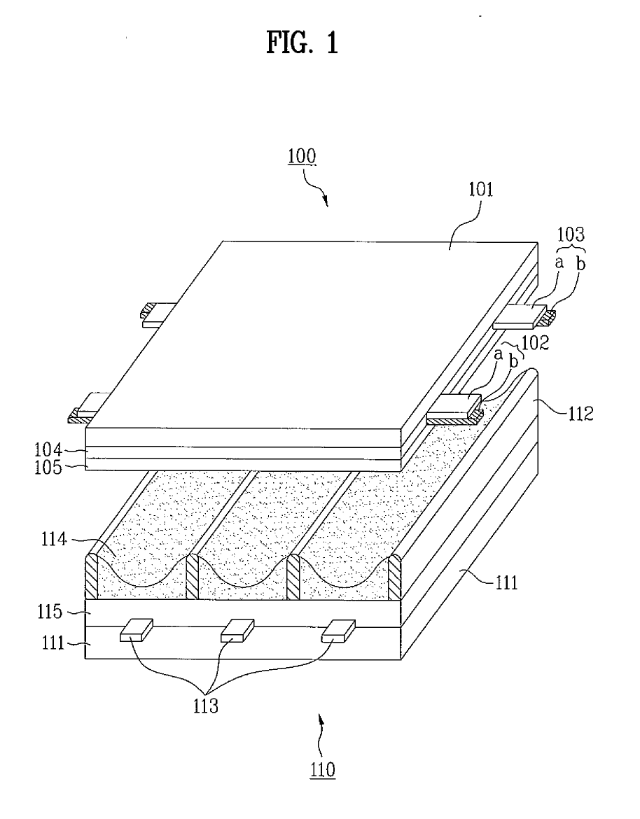

FIG. 2 is a graph showing changes in the firing voltages of different plasma display panels, each of which includes a protective layer composed of magnesium oxide and another oxide; and

FIG. 3 is a section view of an upper panel of a plasma display panel.

### DETAILED DESCRIPTION

A plasma display panel includes a protective layer having a bilayer structure. Hereinafter, a layer formed on one surface of an upper dielectric layer is referred to as a ‘first protective film’, and a layer formed on the first protective film is referred to as a ‘second protective film’.

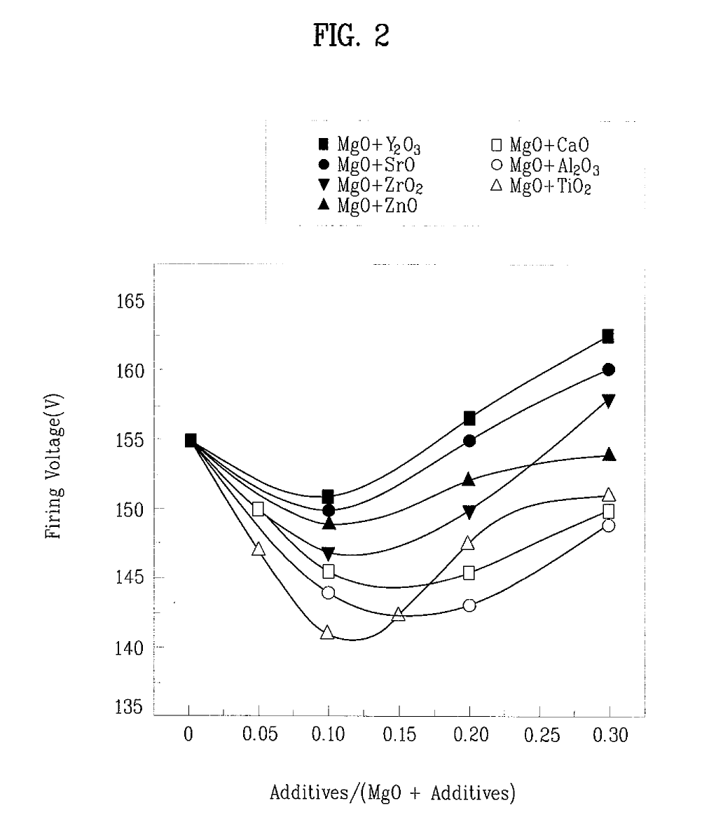

FIG. 2 is a graph showing changes in the firing voltages of different plasma display panels, each of which includes a protective layer composed of magnesium oxide and another oxide. As is apparent from the graph of FIG. 2, the firing voltages of the plasma display panels can be lowered by the addition of various kinds of oxides other than magnesium oxide to the respective protective layers. FIG. 2 also shows changes in the firing voltages of the plasma display panels with increasing amounts of Y₂O₃, SrO, ZrO₂, ZnO, CaO, Al₂O₃ and TiO₂ added as additives. Although there is a difference depending on the kind of the additives, the firing voltages of the plasma display panels generally decrease to the lowest values when the number of moles of the additive constituting each of the protective layers reaches about 10% of the total number of moles of the additive and magnesium oxide.

Based on these results, a plasma display panel may include a protective film which is composed of a mixture of magnesium oxide and another oxide. Other implementations provide a plasma display panel including an additional protective film composed of a crystalline oxide and formed over a protective film that comprises magnesium oxide or a protective film which comprises a mixture of magnesium oxide and another oxide. Implementations are not limited to using a protective film formed from the materials shown in FIG. 2.

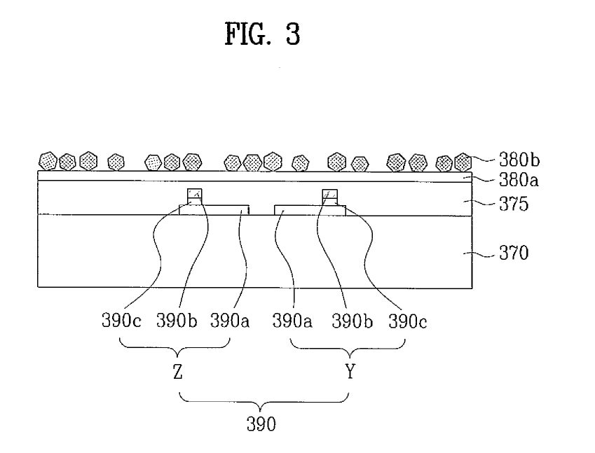

FIG. 3 is a view of an upper panel of a plasma display panel. The plasma display panel includes sustain electrode pairs 390 included in an upper panel and a dielectric layer 375 formed thereon. Each of the sustain electrode pairs 390 includes a transparent electrode 390a and a bus electrode 390b formed on the transparent electrode. A black electrode 390c may be interposed between the transparent electrode 390a and the bus electrode 390b. A first protective film 380a and a second protective film 380b are sequentially formed on the dielectric layer 375. The first protective film 380a is composed of magnesium oxide, and the second protective film 380b is composed of a secondary electron-emitting material.

In certain implementations, crystalline oxide is used as the secondary electron-emitting material. The crystalline oxide is a material that serves to increase the number of secondary electrons emitted to lower the firing voltage of a plasma display panel. The crystalline oxide may be at least one material selected from alkaline earth metal oxides, alkali metal oxides and transition metal oxides. Examples of alkaline earth metal oxides include MgO, BeO, CaO, SrO and BaO, examples of alkali metal oxides include LiO₂, Na₂O, K₂O, Rb₂O and CsO, and examples of transition metal oxides include TiO₂, Y₂O₃, ZrO₂, Ta₂O₅, ZnO, CoO and MnO. In addition to these materials, materials such as Al₂O₃, SiO₂, GeO₂, SnO₂, La₂O₃, CeO₂, Eu₂O₃, and Gd₂O₃ may be used as the crystalline oxide. More generally, any material that is able to be used to increase the number of secondary electrons emitted by the bombardment of ions upon plasma discharge may be used.

In certain implementations, the first protective film 380a has a thickness of 400 to 1,000 nm, and the crystalline oxide constituting the second protective film 380b has a size of 50 to 1,000 nm. The crystalline oxide may have a shape of a cube or a sphere. If the shape of the crystalline oxide is a cube, the size of the crystalline oxide refers to the length of one side of the cube. Meanwhile, if the shape of the crystalline oxide is a sphere, the size of the crystalline oxide refers to the diameter of the sphere. The surface area of the second protective film composed of the crystalline oxide may be established to be as large as possible to increase the number of secondary electrons emitted. To this end, the first protective film 380a may not be completely covered by the second protective film 380b. Specifically, the second protective film 380b may cover about 80% or between 30 to 80% of the surface area of the first protective film 380a. The second protective film 380b may be formed in such a manner that it has a regular or irregular pattern.

Particles of the crystalline oxide, e.g., particles of an alkaline earth metal, are formed on the first protective film, and as a result, the surface of the second protective film is rugged rather than flat. Accordingly, the surface area of the second protective film where ions collide upon discharge increases, resulting in an increase in the number of secondary electrons emitted. This increase in the number of secondary electrons emitted leads to an improvement in the discharge efficiency of the plasma display panel and a reduction in the firing voltage of the plasma display panel. Further, when the second protective film is composed of Gd₂O₃, UV light having a wavelength of about 250 nm is emitted from vacuum ultraviolet (VUV) light of a wavelength of about 147 nm, which is generated from a discharge gas, e.g., Xe, during discharge, resulting in an improvement in the brightness of the plasma display panel.

Next, an explanation of how the second protective film formed on the first protective film serves to increase the number of secondary electrons emitted by the bombardment of electrons is provided below.

The second protective film 380b is composed of a material having a secondary electron emission coefficient, which results from the bombardment of electrons, higher than that of magnesium oxide. The material constituting the second protective film 380b may be single crystalline or polycrystalline. Examples of such single-crystal materials include KBr, KCl, KI, NaBr, NaCl, NaF, NaI and LiF, and examples of such polycrystalline materials include CsCl, KCl, KI, NaBr, NaCl, NaF, NaI, LiF, RbCl, Al₂CO₃, BaO, BeO, BaF₂, CaF₂, BiCs₃, GeCs, Rb₃Sb, and SbCs₃.

The secondary electron emission coefficient of magnesium oxide varies depending on the measurement conditions. Magnesium oxide is measured to have a secondary electron emission coefficient lower than 1 under routine conditions. The secondary electron emission coefficients of the single-crystal materials are as follows: KBr=14, KCl=12, KI=10, NaBr=24, NaCl=14, NaF=14, NaI=19, and LiF=8.5. The secondary electron emission coefficients of the polycrystalline materials are as follows: CsCl=6.5, KCl=7.5, KI=5.6, NaBr=6.3, NaCl=6.8, NaF=5.7, NaI=5.5, LiF=5.6, RbCl=5.8, Al₂CO₃=2-9, BaO=2.3-4.8, BeO=3.4, BaF₂=4.5, CaF₂=3.2, BiCs₃=6, GeCs=7, Rb₃Sb=7.1, and SbCs₃=6. The secondary electron emission coefficient of a material is defined as the number of electrons ejected from the material when one electron collides with the material.

In certain implementations, the first protective film 380a may have a thickness of 400 to 1,000 nm, and the single-crystal or polycrystalline oxide constituting the second protective film 380b may have a size of 50 to 1,000 nm. If the single-crystal or polycrystalline particles are spherical, the size of the particles refers to the diameters of the spheres. Meanwhile, if the single-crystal or polycrystalline particles are cubic, the size of the particles refers to the length of one side of the cube. Increasing the surface area of the second protective film composed of the single-crystal or polycrystalline oxide serves to increase the number of secondary electrons emitted. In general, the first protective film 380a is not completely covered by the second protective film 380b. Specifically, the surface area of the second protective film 380b may be less than 80% or between 30 to 80% of that of the first protective film 380a. That is, the second protective film 380b is formed on the first protective film 380a such that it has an island shape. Since the material constituting the second protective film 380b is not satisfactorily resistant to the bombardment of ions, the second protective film 380b is formed only on portions of the surface of the first protective film 380a. Accordingly, the magnesium oxide constituting the first protective film 380a functions to protect the second protective film 380b, and the second protective film 380b functions to effectively increase the number of secondary electrons emitted by the bombardment of ions and electrons.

A method for producing a plasma display panel such as is described above is different from conventional methods in that a protective layer having a bilayer structure is formed. Specifically, a plasma display panel is produced by the following procedure. First, sustain electrode pairs are formed on a glass substrate. Thereafter, a dielectric layer is formed on the glass substrate and the sustain electrode pairs. A first protective film and a second protective film are sequentially formed on the dielectric layer. At this time, the first protective film is composed of magnesium oxide, and the second protective film is composed of a secondary electron-emitting material. The kind and size of the secondary electron-emitting material and the shape of the second protective film are as described above. That is, the secondary electron-emitting material is a crystalline oxide and is present in the form of particles within the second protective film. Also, the second protective film is composed of a material having a secondary electron emission coefficient, which results from the bombardment of electrons, higher than that of magnesium oxide.

The second protective film composed of crystalline oxide particles may be formed by preparing a liquid paste, applying the liquid paste on the first protective film, and drying and calcining the applied liquid paste. The liquid paste used to form the second protective film may be applied to portions of the surface of the first protective film. This application of the liquid paste is performed by a process selected from spray coating, bar coating, spin coating, blade coating, and inkjet printing. The liquid paste is prepared by milling a crystalline oxide powder, such as BeO powder, and mixing the milled powder with a solvent and a dispersant. As the amount of the powder increases (i.e. the content of the powder in the final liquid paste increases), the area of the second protective film formed on the first protective film increases.

The formation of a second protective film composed of a material having a secondary electron emission coefficient, which results from the bombardment of electrons, higher than that of magnesium oxide is achieved by the following example procedure. First, a first protective film essentially composed of magnesium oxide is formed by a conventional process selected from e-beam deposition, ion plating, sputtering and screen printing. Subsequently, a second protective film is formed on the first protective film such that it has an island shape. The second protective film may be formed by liquid-phase deposition, green sheet lamination or spray coating. When it is intended to form the second protective film having an island shape by green sheet lamination, patterning may be performed in subsequent processing. According to liquid-phase deposition, the concentration of a powder in a liquid paste can be controlled. According to spray coating, the material for the second protective film can be sprayed through a mask disposed on the first protective film.

An example method for forming the second protective film by liquid-phase deposition includes preparing a liquid paste, applying the liquid paste on the first protective film, and drying and calcining the applied first protective film. First, a crystalline powder, such as a single-crystal KBr or polycrystalline CsCl powder, is milled. The milled powder is mixed with a solvent and a dispersant to prepare a liquid paste. At this time, the powder may be present in an amount of 1 to 30% by weight with respect to the total weight of the liquid paste, and the dispersant may be present in an amount of 5 to 60% by weight with respect to the weight of the powder. As the amount of the powder increases (i.e. the content of the powder in the final liquid paste increases), the area of the second protective film formed on the first protective film increases.

Subsequently, the liquid paste is applied to the first protective film. The application of the liquid paste may be performed by screen printing, dipping, dye coating or spin coating. Thereafter, the applied liquid paste is dried and calcined to complete the formation of the second protective film. The second protective film thus formed emits an increased number of secondary electrons due to the bombardment of electrons, and as a result, the firing voltage and power consumption of a plasma display panel including the second protective film can be reduced.

Other implementations are within the scope of the following claims.

What is claimed is:

1. A plasma display panel comprising:
a glass plate;
a plurality of electrodes formed on the glass plate;
a dielectric layer covering the plurality of electrodes;
a first protective film formed on the dielectric layer; and
a second protective film formed on the first protective film.

2. The plasma display panel of claim 1, wherein the first protective film comprises magnesium oxide and the second protective film comprises a secondary electron-emitting material.

3. The plasma display panel of claim 2, wherein the secondary electron-emitting material is crystalline oxide.

4. The plasma display panel of claim 3, wherein the crystalline oxide is alkaline earth metal oxide, alkali metal oxide, or transition metal oxide.

5. The plasma display panel of claim 4, wherein the alkaline earth metal oxide is MgO, BeO, CaO, SrO, or BaO.

6. The plasma display panel of claim 4, wherein the alkali metal oxide is LiO₂, Na₂O, K₂O, Rb₂O, or CsO.

7. The plasma display panel of claim 4, wherein the transition metal oxide is TiO₂, Y₂O₃, ZrO₂, Ta₂O₅, ZnO, CoO, or MnO.

8. The plasma display panel of claim 3, wherein the crystalline oxide is Al₂O₃, SiO₂, GeO₂, SnO₂, La₂O₃, CeO₂, Eu₂O₃, or Gd₂O₃.

9. The plasma display panel of claim 1, wherein the second protective film comprises a material having a secondary electron emission coefficient, which is higher than a secondary electron emission coefficient of magnesium oxide.

10. The plasma display panel of claim 1, wherein the second protective film comprises particles of a single-crystal material.

11. The plasma display panel of claim 10, wherein the single-crystal material is KBr, KCl, KI, NaBr, NaCl, NaF, NaI, or LiF.

12. The plasma display panel of claim 1, wherein the second protective film comprises particles of a polycrystalline material.

13. The plasma display panel of claim 12, wherein the polycrystalline material is CsCl, KCl, KI, NaBr, NaCl, NaF, NaI, LiF, RbCl, Al2CO3, BaO, BeO, BaF₂, CaF₂, BiCs₃, GeCs, Rb₃Sb, or SbCs₃.

14. A method of manufacturing a plasma display panel, comprising:
providing a glass substrate;
forming a plurality of electrodes on the glass substrate;
forming a dielectric layer on the plurality of electrodes;
forming a first protective film on the dielectric layer; and
forming a second protective film on the first protective film.

15. The method of claim 14, wherein the first protective film comprises magnesium oxide and the second protective film comprises crystalline oxide.

16. The method of claim 14, wherein forming the second protective film comprises applying a liquid paste on the first protective film and drying and calcining the liquid paste applied on the first protective film.

17. The method of claim 16, wherein applying the liquid paste is performed by spray coating, bar coating, spin coating, blade coating, or inkjet printing.

18. The method of claim 14, wherein the second protective film comprises a secondary electron-emitting material having a secondary electron emission coefficient that is higher than a secondary electron emission coefficient of magnesium oxide.

19. The method of claim 18, wherein the second protective film is formed by liquid-phase deposition, green sheet lamination, or spray coating.

20. The method of claim 19, wherein the liquid-phase deposition is performed by applying a liquid paste of the secondary electron-emitting material on the first protective film, drying the applied liquid paste, and calcining the dried liquid paste.

21. The method according to claim 20, wherein forming the second protection film comprises controlling an area of the second protection film by varying a concentration of the secondary electron-emitting material in the liquid paste.

22. A plasma display panel comprising:
a glass plate;
a plurality of electrodes formed on the glass plate;
a dielectric layer covering the plurality of electrodes; and
a protective film formed on the dielectric layer which comprises a mixture of a first oxide and a second oxide.

23. The plasma display panel of claim 22, wherein the first oxide is magnesium oxide and the second oxide is crystalline oxide.

24. The plasma display panel of claim 23, wherein the crystalline oxide is Y₂O₃, SrO, ZrO₂, ZnO, CaO, Al₂O₃ or TiO₂.
